(19) United States
(12) Patent Application Publication
(10) Pub. No.: US 2021/0028953 A1
(43) Pub. Date: Jan. 28, 2021

(54) ONLINE MEETING FAILOVER TO NON-VIDEO CONNECTION

(71) Applicant: Microsoft Technology Licensing, LLC, Redmond, WA (US)

(72) Inventors: Nakul MADAAN, Prague (CZ); Dominic ROEDEL, Prague (CZ); Ewin DAVIS KANNUTHOTTIYIL, Prague (CZ)

(21) Appl. No.: 16/520,124

(22) Filed: Jul. 23, 2019

(51) Int. Cl. H04L 12/18; H04N 7/15; H04L 29/14

(52) U.S. Cl. CPC H04L 12/1827; H04L 69/40; H04N 7/152; H04L 12/1822

(57) ABSTRACT

Online conference technology that permits failing over an online meeting to a non-video connection with the online meeting. While video is often important content of an online meeting, video connections are not always possible. The principles described herein failover to a non-video connection when a video connection is not to be made or continued between an online meeting that is hosted by an online meeting computing system and a participant computing system that interfaces with a participant in the online meeting. As examples, that non-video connection might include audio and potentially a sequence of images (albeit not video). Thus, a user might continue to listen to the online meeting, and may view presentations of image sequences, and may even view image samples of video being presented.

### BACKGROUND

Human beings are a unique species in our ability to communicate one with another. Our ability to effectively share information and mutually exchange ideas contributes to almost every aspect of the advancement and happiness of humankind. Relationships are strengthened. Technological achievement is accelerated. Knowledge and wisdom can be passed from one generation or person to another. We learn from the perspectives, experiences, and knowledge of others. We work more efficiently and collaboratively. Notwithstanding, human beings are imperfect at communicating, and thus ideas are sometimes lost, or misunderstandings can occur. Thus, we sometimes fall short of our full potential.

Computing and network technologies provide additional avenues for sharing information and ideas, thereby increasing the available modalities of communication and information sharing. For instance, we can now participate in and record online meetings and conference to share information and collaborate, even from remote locations. There are various modalities of communication possible in online conferences. For instance, audio and video content may be shared. Desktops and windows may be shared between users. Furthermore, users may mutually add content or edit documents. Notwithstanding, various problems could arise when the user attempts to join an online meeting, which could prevent the user from joining. Furthermore, a user could potentially even be dropped from an online meeting if network connectivity deteriorates over the course of the online meeting.

The subject matter claimed herein is not limited to embodiments that solve any disadvantages or that operate only in environments such as those described above. Rather, this background is only provided to illustrate one exemplary technology area where some embodiments describe herein may be practiced.

### BRIEF SUMMARY

Embodiments disclosed herein relate to online conference technology that permits failing over an online meeting from a full meeting experience (or at least a meeting experience that includes video provided over a video connection with the online meeting) to a limited meeting experience. The limited meeting experience provides less functionality than the full meeting experience. For instance, the limited meeting experience might not include a video connection with the online meeting.

While video is often important content of an online meeting, video connections are not always possible. For instance, it might not even be possible to create a video connection with the online conference if the user is attempting to join via an unsupported browser or there is some network configuration (e.g., network port access) setting that is preventing the creation of a video connection. Even after successfully joining a meeting with full video connection, the quality of the video connection may deteriorate over time, resulting in glitchy video or even potentially a dropped connection with the online meeting.

The principles described herein allow for failover to a non-video connection when a video connection is not to be made or continued between an online meeting that is hosted by an online meeting computing system and a participant computing system that interfaces with a participant that is participating in the online meeting. As examples, that non-video connection might include audio and potentially a sequence of images (albeit not video). Thus, a user might continue to listen to the online meeting, and may view or present presentations of image sequences, and may even view image samples of video being presented. Thus, instead of the user simply suffering through low performance video problems, or even being dropped from the online conference, the online conference may continue with the user still being able to participate. Likewise, the other participants are not burdened with having to wait for the participant to rejoin should that participant be inadvertently dropped from the online conference.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and details through the use of the accompanying drawings in which:

FIG. 1 illustrates a network environment in which the principles described herein may operate, the network environment including multiple participants that are connected to an online meeting;

FIG. 2 illustrates a flowchart of a method for failing over an online meeting to a non-video connection with the online meeting, in accordance with the principles described herein;

FIG. 3 illustrates a flowchart of a method for obtaining (if after a failover at join) or restoring (if after a mid-meeting failover) a video connection to an online meeting;

FIG. 4 illustrates a flowchart of a method for providing the non-video connection, and represents an example of the second act of FIG. 2;

FIG. 5 illustrates a flowchart of a method for providing the non-video connection, and represents another example of the second act of FIG. 2;

FIG. 6 illustrates a logical flow associated with one example implementation of a full meeting experience (with video) as well as a limited meeting experience (without video); and

FIG. 7 illustrates an example computing system in which the principles described herein may be employed.

### DETAILED DESCRIPTION

Embodiments disclosed herein relate to online conference technology that permits failing over an online meeting from a full meeting experience (or at least a meeting experience that includes video provided over a video connection with the online meeting) to a limited meeting experience. The limited meeting experience provides less functionality than the full meeting experience. For instance, the limited meeting experience might not include a video connection with the online meeting.

While video is often important content of an online meeting, video connections are not always possible. For instance, it might not even be possible to create a video connection with the online conference if the user is attempting to join via an unsupported browser or there is some network configuration (e.g., network port access) setting that is preventing the creation of a video connection. Even after successfully joining a meeting with full video connection, the quality of the video connection may deteriorate over time, resulting in glitchy video or even potentially a dropped connection with the online meeting.

The principles described herein allow for failover to a non-video connection when a video connection is not to be made or continued between an online meeting that is hosted by an online meeting computing system and a participant computing system that interfaces with a participant that is participating in the online meeting. As examples, that non-video connection might include audio and potentially a sequence of images (albeit not video). Thus, a user might continue to listen to the online meeting, and may view or present presentations of image sequences, and may even view image samples of video being presented. Thus, instead of the user simply suffering through low performance video problems, or even being dropped from the online conference, the online conference may continue with the user still being able to participate. Likewise, the other participants are not burdened with having to wait for the participant to rejoin should that participant be inadvertently dropped from the online conference.

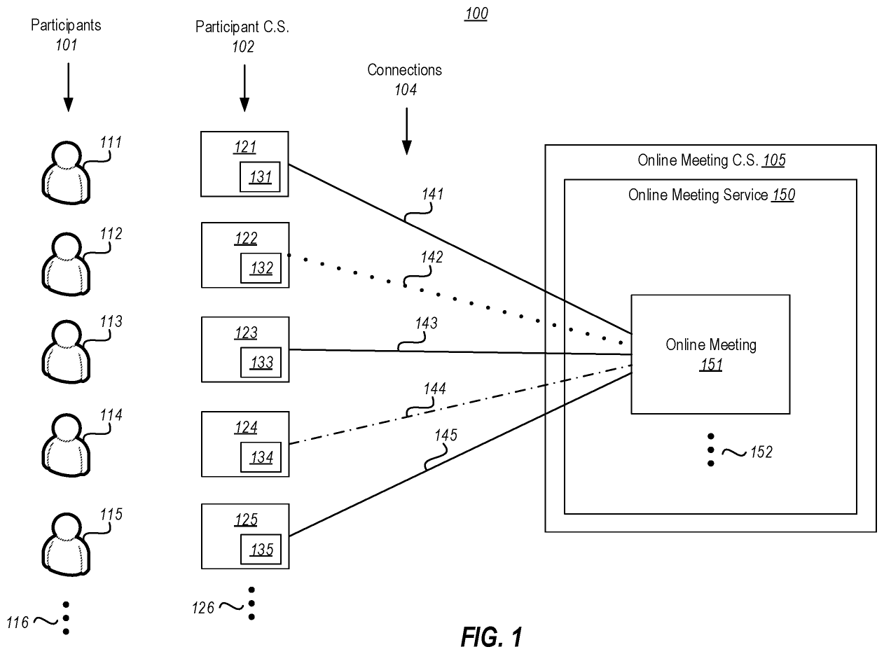

FIG. 1 illustrates a network environment 100 in which the principles described herein may operate. The network environment 100 includes multiple participants 101 that are to be connected to an online meeting 151. Each participant 101 is a user that operates an associated computing system 102 (also called herein “participant computing systems” in the plural, or a “participant computing system” in the singular). In this particular example, there are five participants 111 through 115, each operating an associated participant computing system 121 through 125. However, the ellipses 116 and 126 represent that this is just an example, as there may be any number of participants connected to an online meeting, and as the number of participants in any given online meeting may change over time.

Each participant computing system 121 through 125 operates an associated client application 131 through 135 that the participant computing system may use to connect at the application-level to the online meeting 151. The online meeting 151 represents a meeting (amongst potentially multiple online meetings as represented by the ellipsis 152) that is hosted by a meeting service 150 on an online meeting computing system 105.

Each of the participant computing systems 102 is illustrated as having a respective connection 104 with the online meeting 151. This means that the meeting service 150 can present content associated with the online meeting 151 to each respective participant computing system 121 through 125 using the associated connection 141 through 145. Furthermore, in a collaborative online meeting experience, the connections 141 through 145 may be used to convey meeting content in the other direction from the respective participant computing systems 121 through 125 to the online meeting service 150.

In this example, the connections 141, 143 and 145 are reliable connections that enable a full online meeting experience that includes video content being exchanged (in at least one direction and potentially bi-directionally). Accordingly, the connections 141, 143 and 145 are represented using solid lines. Also, in this example, the connection 142 is a low-bandwidth connection enabling a partial online experience that does not support video exchange. Accordingly, the connection 142 is represented using a dotted line. Lastly, in this example, the connection 144 is a connection whose bandwidth sometimes, but not always, supports a full online meeting experience. Accordingly, the connection 144 is represented using an intermittent dotted-dashed line.

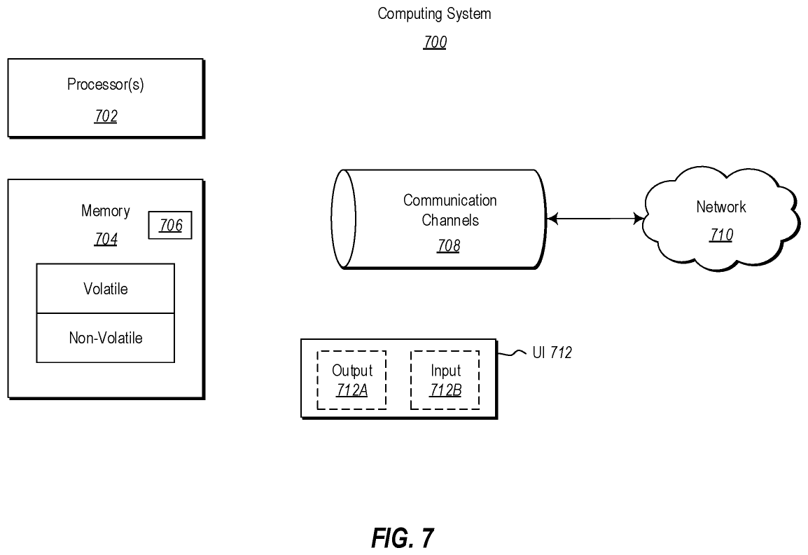

The online meeting computing system 105 and each of the participant computing systems 102 may be any computing system (or collection thereof) such as the computing system 700 described below with respect to FIG. 7. In that case, the online meeting service 150 and each of the client applications 131 through 135 may be structured as described below for the executable component 706 of FIG. 7. For any given participant computing system 102, the methods described herein may be accomplished for a given participant computing system either by the associated client application running on that participant computing system, by the online meeting service 150, or collaboratively by both.

In any case, whatever method or part thereof that is performed by the client application, the client application performs that act potentially in software by one or more of its processors of the respective participant computing system executing one or more computer-executable instructions that are present on its computer-readable media. For instance, if the participant computing system is structured as described below for the computing system 700 of FIG. 7, that computer-readable media might be the memory 704, and the one or more processors might be the at least one hardware processing unit 702.

Furthermore, whatever method or part thereof that is performed by the meeting service (e.g., meeting service 150), the meeting service performs that act potentially in software by one or more of its processors of the online meeting computing system 105 executing one or more computer-executable instructions that are present on its computer-readable media. For instance, if the online meeting computing system 105 is structured as described below for the computing system 700 of FIG. 7, that computer-readable media might be the memory 704, and the one or more processors might be the at least one hardware processing unit 702.

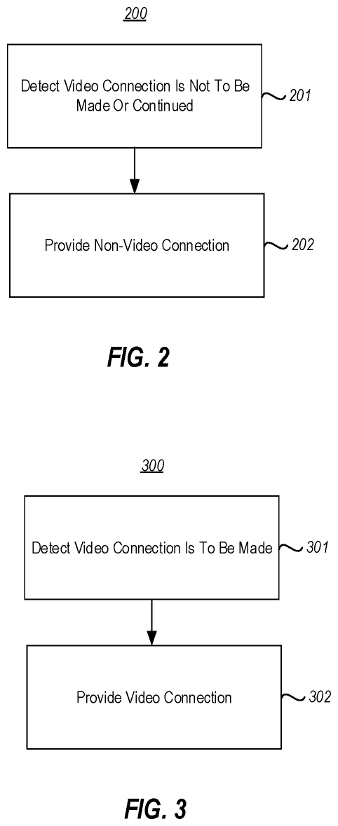

FIG. 2 illustrates a flowchart of a method 200 for failing over an online meeting to a non-video connection (or more generally a limited meeting experience) with the online meeting. The method 200 includes detecting that a video connection (or more generally a full meeting experience) to a meeting service is not to be made or continued with an online meeting that is hosted by an online meeting computing system (act 201), and in response, providing a non-video connection with the online meeting (act 202). Similarly, FIG. 3 illustrates a flowchart of a method 300 for obtaining or restoring a video connection to an online meeting after failover. The method 300 includes detecting that a video connection to the meeting service is to be made (act 301), and in response, providing the video connection with the online meeting (act 302).

This failing over method 200 of FIG. 2 (or the restoration method 300 of FIG. 3) may occur in the context of the network environment 100 of FIG. 1. Accordingly, the methods 200 and 300 will now be described with frequent reference to FIGS. 1 through 3. Hereinafter, a “full connection” with an online meeting service refers to a connection that enables video content to be delivered at least in one direction.

The failing over method 200 may occur at the time that the full connection is attempted (also called herein a “failover at join”). A failover at join example will be described further below with respect to the connection 142 of FIG. 1. Alternatively, the failing over method 200 may occur after the full connection has been achieved (also called herein a “mid-meeting failover”). A mid-meeting failover example will be described with respect to the connection 144 of FIG. 1.

The failing over method 200 may be performed multiple times even during the course of a single online meeting. For instance, there might be a failover at join (one instance of method 200), followed by an obtaining of the full connection (one instance of method 300), and then later a mid-meeting failover (another instance of method 200). Alternatively, whether or not there was a failover at join, there may be multiple mid-meeting failovers (and thus one or more restorations of the full connection) in the course of the online meeting.

The failover at join example will now be described with respect to the method 200 of FIG. 2, and the connection 142 of FIG. 1. The method 200 includes detecting that a video connection to a meeting service is not to be made in the case of a failover at join (act 201). Referring to FIG. 1, the connection 142 has at one end the participant computing system 122 that interfaces with a participant 112 that is to participate (e.g., attend) the online meeting 151. The connection 142 has at the other end the online meeting 151 hosted by the online meeting computing system 105. In a failover at join, the detection that the video connection is not to be made (act 201) occurs in response to an attempt to join the participant 112 into the online meeting 151.

The detection that the video connection is not to be made (act 201) may be in response to a determination that the application 132 cannot establish a video connection with the online meeting 151. Recall that the application 132 runs on the participant computing system 122 and is to provide online meeting content from the online meeting 151 to the participant 112. For instance, the application 132 might not be able to establish a full connection with the online meeting 151, the online meeting service 150 or the online meeting computing system 105. This might occur if the application 132 was an unsupported browser for the online meeting service 150. This might also happen if the application 132 or the participant computing system 122 has a network access configuration setting (e.g., a network port access setting, or a policy setting) that prevents establishment of a full connection with the online meeting 151.

In response to detecting that the video connection is not to be made, the method 200 includes providing a non-video connection between the participant computing system and an online meeting (act 202). For instance, the connection 142 may be a non-video connection. The non-video connection 142 allows audio, but not video, (and potentially other non-video content) to be delivered to the participant computing system 122 for rendering to the participant 112. Thus, a partial online meeting experience is enabled for the user. As additional possibilities, the partial online meeting experience might allow still image sequences (e.g., a slide deck) to be presented to and/or shared by the participant. As another possibility, the partial online meeting experience might allow for low frequency sampling of images of the video to be presented to the user (e.g., on the order of one frame per second or lower). Thus, the partial online meeting experience allows the user to meaningfully attend the online meeting even if the connection is not suitable (bandwidth-wise and/or configuration-wise) for reliable exchange of video.

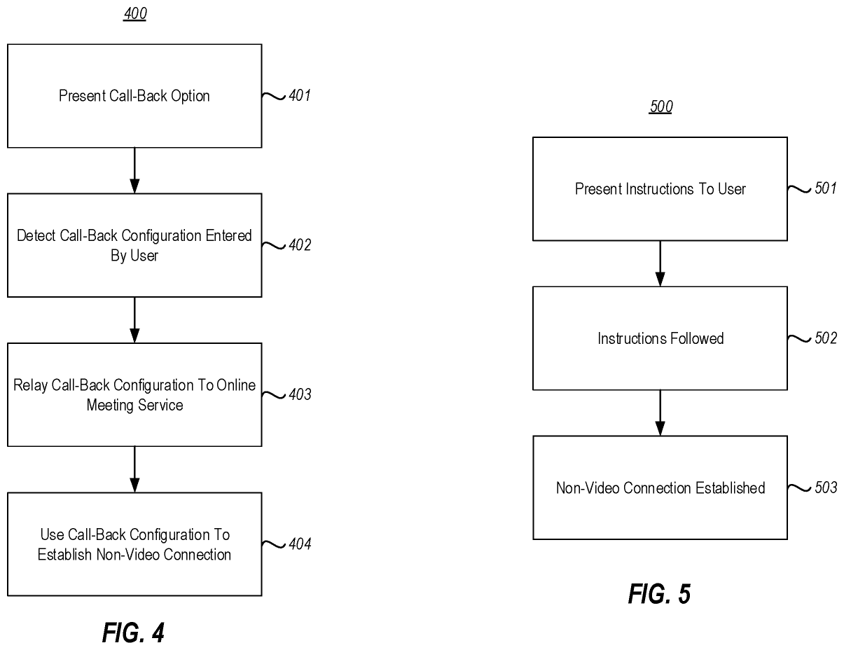

FIG. 4 illustrates a flowchart of a method 400 for providing the non-video connection, and represents an example of the act 202 of FIG. 2. Here, the participant computing system is caused to present a call-back option to the participant (act 401). The participant computing system then detects that the user has entered call-back configuration (e.g., a telephone number) (act 402) in response to being presented the call-back option (act 401). This call-back configuration is relayed to the online meeting service (act 403), which then establishes the non-video connection using the call-back configuration (act 404).

FIG. 5 illustrates a flowchart of a method 500 for providing the non-video connection, and represents another example of the act 202 of FIG. 2. Here, the participant computing system is caused instructions to the participant (act 501). The instructions are configured such that, when followed (act 502), the non-video connection is established (act 503).

The mid-meeting failover example will now be described with respect to the method 200 of FIG. 2, and the connection 144 of FIG. 1. The method 200 includes detecting that a video connection to a meeting service is not to be continued (act 201) in the case of a mid-meeting failover. Referring to FIG. 1, the connection 144 has at one end the participant computing system 124 that interfaces with a participant 114 that is to participate (e.g., attend) the online meeting 151. The connection 144 has at the other end the online meeting 151 hosted by the online meeting computing system 105. In the case of a mid-meeting failover, the detection that the video connection is not to be continued (act 201) may occur in response to monitoring video quality presented over the video connection. If the video quality becomes too low and/or the data presented over the connection is about to overwhelm the connection, then the detection might be that the video connection is not to be continued (act 201). In that case, the non-video connection is provided (act 202). This might also be done by way of call-back (as in method 400) or instruction (as in method 500).

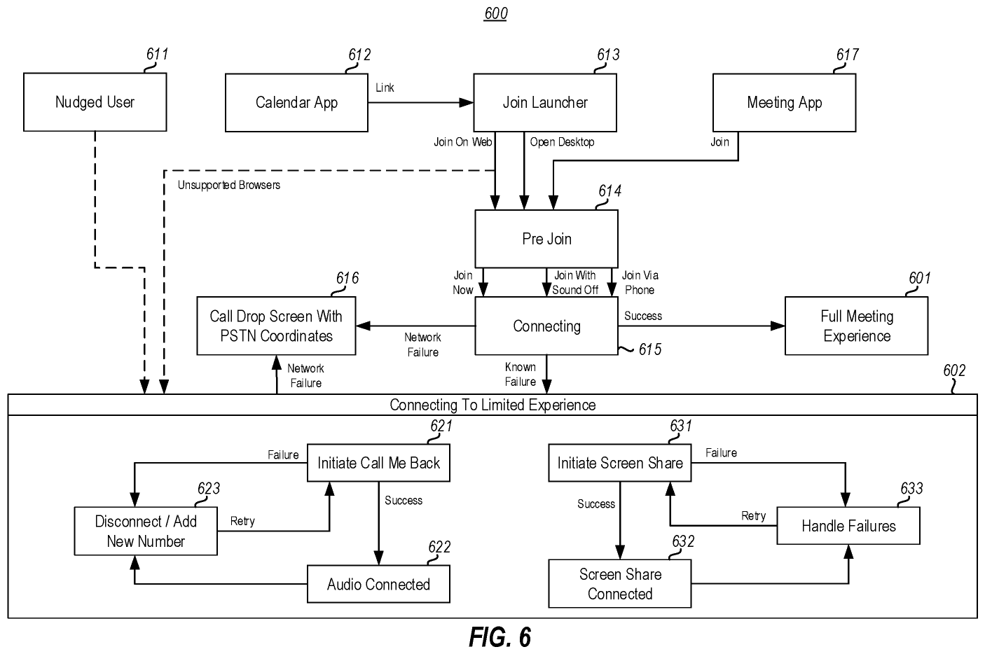

FIG. 6 illustrates a logical flow 600 associated with one example implementation of a full meeting experience 601 (with video) as well as a limited meeting experience 602 (without video). Here, the user might be joined into a limited meeting experience in a number of ways.

For instance, a user might be nudged (act 611) to be joined into a limited experience. That is, the user might be invited impromptu into the limited experience. When a user is nudged, the user may not have advanced notice that the meeting is occurring. Thus, their resources to join a meeting (and establish a full connection to the online meeting) may be more limited depending on their circumstances at the time. By nudging into a limited meeting experience 602, versus the full meeting experience 601, there is greater reliability in ensuring that the connection is available.

As another example, the user might enter a meeting from a calendar application 612, in which the user is given the option to join a meeting via selection of a link. If the user selects the link, a join launcher application 613 gives the user the option of joining via the web, or opening a desktop. If the user selects to join via the web, but the user is using an unsupported browser, then the user enters the limited meeting experience 602. In the join launcher application 613, if the user joins via the web using a supported browser, or opens the desktop to join, then the user is presented into a pre-join state 614. Alternatively, if the user joins from a dedicated meeting application 617, the user might also enter the pre-join state 614. In the pre-join state 614, the user is given the option to join the meeting now, join with the sound off, or join via their phone.

The connection to the full meeting experience is then attempted (see state 615). If the connection is successful, the user enters the full meeting experience 601. Otherwise, if there is a network failure, there may be a call drop screen presented (see state 616). If there is a known failure, then the user is entered into the limited experience 602.

In the limited experience 602, audio may be achieved using the initiate call back prompt 621. If successful, then audio is connected (see state 622). If there is a failure, the call is disconnected, and the user is given the option to enter a new number (see state 623). Also, in the limited experience 602, screen sharing may be achieved using the initiate screen share prompt 631. If successful, then screen share is connected (see state 632). If there is a failure, then a failure handling mechanism is triggered (see state 633).

Because the principles described herein may be performed in the context of a computing system, some introductory discussion of a computing system will be described with respect to FIG. 7. Computing systems are now increasingly taking a wide variety of forms. Computing systems may, for example, be handheld devices, appliances, laptop computers, desktop computers, mainframes, distributed computing systems, data centers, or even devices that have not conventionally been considered a computing system, such as wearables (e.g., glasses). In this description and in the claims, the term “computing system” is defined broadly as including any device or system (or a combination thereof) that includes at least one physical and tangible processor, and a physical and tangible memory capable of having thereon computer-executable instructions that may be executed by a processor. The memory may take any form and may depend on the nature and form of the computing system. A computing system may be distributed over a network environment and may include multiple constituent computing systems.

As illustrated in FIG. 7, in its most basic configuration, a computing system 700 typically includes at least one hardware processing unit 702 and memory 704. The processing unit 702 may include a general-purpose processor and may also include a field programmable gate array (FPGA), an application specific integrated circuit (ASIC), or any other specialized circuit. The memory 704 may be physical system memory, which may be volatile, non-volatile, or some combination of the two. The term “memory” may also be used herein to refer to non-volatile mass storage such as physical storage media. If the computing system is distributed, the processing, memory and/or storage capability may be distributed as well.

The computing system 700 also has thereon multiple structures often referred to as an “executable component”. For instance, the memory 704 of the computing system 700 is illustrated as including executable component 706. The term “executable component” is the name for a structure that is well understood to one of ordinary skill in the art in the field of computing as being a structure that can be software, hardware, or a combination thereof. For instance, when implemented in software, one of ordinary skill in the art would understand that the structure of an executable component may include software objects, routines, methods, and so forth, that may be executed on the computing system, whether such an executable component exists in the heap of a computing system, or whether the executable component exists on computer-readable storage media.

In such a case, one of ordinary skill in the art will recognize that the structure of the executable component exists on a computer-readable medium such that, when interpreted by one or more processors of a computing system (e.g., by a processor thread), the computing system is caused to perform a function. Such structure may be computer readable directly by the processors (as is the case if the executable component were binary). Alternatively, the structure may be structured to be interpretable and/or compiled (whether in a single stage or in multiple stages) so as to generate such binary that is directly interpretable by the processors. Such an understanding of example structures of an executable component is well within the understanding of one of ordinary skill in the art of computing when using the term “executable component”.

The term “executable component” is also well understood by one of ordinary skill as including structures, such as hard coded or hard wired logic gates, that are implemented exclusively or near-exclusively in hardware, such as within a field programmable gate array (FPGA), an application specific integrated circuit (ASIC), or any other specialized circuit. Accordingly, the term “executable component” is a term for a structure that is well understood by those of ordinary skill in the art of computing, whether implemented in software, hardware, or a combination. In this description, the terms “component”, “agent”, “manager”, “service”, “engine”, “module”, “virtual machine” or the like may also be used. As used in this description and in the case, these terms (whether expressed with or without a modifying clause) are also intended to be synonymous with the term “executable component”, and thus also have a structure that is well understood by those of ordinary skill in the art of computing.

In the description that follows, embodiments are described with reference to acts that are performed by one or more computing systems. If such acts are implemented in software, one or more processors (of the associated computing system that performs the act) direct the operation of the computing system in response to having executed computer-executable instructions that constitute an executable component. For example, such computer-executable instructions may be embodied on one or more computer-readable media that form a computer program product. An example of such an operation involves the manipulation of data. If such acts are implemented exclusively or near-exclusively in hardware, such as within a FPGA or an ASIC, the computer-executable instructions may be hard-coded or hard-wired logic gates. The computer-executable instructions (and the manipulated data) may be stored in the memory 704 of the computing system 700. Computing system 700 may also contain communication channels 708 that allow the computing system 700 to communicate with other computing systems over, for example, network 710.

While not all computing systems require a user interface, in some embodiments, the computing system 700 includes a user interface system 712 for use in interfacing with a user. The user interface system 712 may include output mechanisms 712A as well as input mechanisms 712B. The principles described herein are not limited to the precise output mechanisms 712A or input mechanisms 712B as such will depend on the nature of the device. However, output mechanisms 712A might include, for instance, speakers, displays, tactile output, virtual or augmented reality, holograms and so forth. Examples of input mechanisms 712B might include, for instance, microphones, touchscreens, virtual or augmented reality, holograms, cameras, keyboards, mouse or other pointer input, sensors of any type, and so forth.

Embodiments described herein may comprise or utilize a special-purpose or general-purpose computing system including computer hardware, such as, for example, one or more processors and system memory, as discussed in greater detail below. Embodiments described herein also include physical and other computer-readable media for carrying or storing computer-executable instructions and/or data structures. Such computer-readable media can be any available media that can be accessed by a general-purpose or special-purpose computing system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: storage media and transmission media.

Computer-readable storage media includes RAM, ROM, EEPROM, CD-ROM, or other optical disk storage, magnetic disk storage, or other magnetic storage devices, or any other physical and tangible storage medium which can be used to store desired program code means in the form of computer-executable instructions or data structures and which can be accessed by a general-purpose or special-purpose computing system.

A “network” is defined as one or more data links that enable the transport of electronic data between computing systems and/or modules and/or other electronic devices. When information is transferred or provided over a network or another communications connection (either hardwired, wireless, or a combination of hardwired or wireless) to a computing system, the computing system properly views the connection as a transmission medium. Transmission media can include a network and/or data links which can be used to carry desired program code means in the form of computer-executable instructions or data structures and which can be accessed by a general-purpose or special-purpose computing system. Combinations of the above should also be included within the scope of computer-readable media.

Further, upon reaching various computing system components, program code means in the form of computer-executable instructions or data structures can be transferred automatically from transmission media to storage media (or vice versa). For example, computer-executable instructions or data structures received over a network or data link can be buffered in RAM within a network interface module (e.g., a “NIC”), and then be eventually transferred to computing system RAM and/or to less volatile storage media at a computing system. Thus, it should be understood that storage media can be included in computing system components that also (or even primarily) utilize transmission media.

Computer-executable instructions comprise, for example, instructions and data which, when executed at a processor, cause a general-purpose computing system, special-purpose computing system, or special-purpose processing device to perform a certain function or group of functions. Alternatively, or in addition, the computer-executable instructions may configure the computing system to perform a certain function or group of functions. The computer executable instructions may be, for example, binaries or even instructions that undergo some translation (such as compilation) before direct execution by the processors, such as intermediate format instructions such as assembly language, or even source code.

Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computing system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, datacenters, wearables (such as glasses) and the like. The invention may also be practiced in distributed system environments where local and remote computing system, which are linked (either by hardwired data links, wireless data links, or by a combination of hardwired and wireless data links) through a network, both perform tasks. In a distributed system environment, program modules may be located in both local and remote memory storage devices.

Those skilled in the art will also appreciate that the invention may be practiced in a cloud computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

For the processes and methods disclosed herein, the operations performed in the processes and methods may be implemented in differing order. Furthermore, the outlined operations are only provided as examples, an some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicate by the appended claims rather than by the foregoing description. All changes which come within the meaning and range of equivalency of the claims are to be embraced within their scope.

What is claimed is:

1. A computing system comprising:
one or more processors; and
one or more computer-readable media having thereon computer-executable instructions that are structured such that, when executed by the one or more processors, cause the computing system to perform a method for failing over an online meeting to a non-video connection with the online meeting, the method comprising:
detect that a video connection to a meeting service is not to be made or continued between an online meeting that is hosted by an online meeting computing system and a participant computing system that interfaces with a participant in the online meeting; and
in responding to the detection, provide a non-video connection between the participant computing system and an online meeting.

2. The computing system in accordance with claim 1, the providing of the non-video connection comprising:
causing the participant computing system to present a call-back option to the participant, where in response to the participant entered call-back configuration in response to the presented call-back option, the non-video connection is established.

3. The computing system in accordance with claim 1, the providing of the non-video connection comprising:
causing instructions to be presented to the participant via the participant computing system to present a call-back option to the participant, where in response to the participant following the instructions, the non-video connection is established.

4. The computing system in accordance with claim 1, the non-video connection allowing audio, but not video, to be delivered to the participant computing system for rendering to the participant.

5. The computing system in accordance with claim 4, the non-video connection also allowing still image sequences, but not video, to be delivered to the participant computing system for rendering to the participant.

6. The computing system in accordance with claim 1, the non-video connection allowing audio, but not video, to be delivered to the participant computing system for rendering to the participant.

7. The computing system in accordance with claim 1, the detection being a detection that a video connection is not to be made.

8. The computing system in accordance with claim 7, the detection that a video connection is not to be made occurring in response to attempting to join the participant into the online meeting.

9. The computing system in accordance with claim 7, the detection that a video connection is not to be made being in response to a determination that an application running on the participant computing system and that is to providing online meeting content to the participant cannot establish a video connection with the online meeting.

10. The computing system in accordance with claim 7, the detection that a video connection is not to be made being in response to a determination that network access configuration on the participant computing system prevents the establishment a video connection with the online meeting.

11. The computing system in accordance with claim 1, the detection being a detection that a video connection is not to be continued.

12. The computing system in accordance with claim 11, the detection that the video connection is not to be continued occurring after a video connection had already been established between the online meeting and the participant computing system.

13. The computing system in accordance with claim 12, the detection that the video connection is not to be continued occurring in response to monitoring video quality presented over the video connection.

14. A method for failing over an online meeting to a non-video connection with the online meeting, the method comprising:
detecting that a video connection to a meeting service is not to be made or continued between an online meeting that is hosted by an online meeting computing system and a participant computing system that interfaces with a participant in the online meeting; and
in responding to the detection, providing a non-video connection between the participant computing system and an online meeting.

15. The method in accordance with claim 14, the non-video connection allowing still image sequences, but not video, to be delivered to the participant computing system for rendering to the participant.

16. The method in accordance with claim 14, the non-video connection allowing audio, but not video, to be delivered to the participant computing system for rendering to the participant.

17. The method in accordance with claim 14, the detection being a detection that a video connection is not to be made, the detection that a video connection is not to be made occurring in response to attempting to join the participant into the online meeting.

18. The method in accordance with claim 14, the detection being a detection that a video connection is not to be continued, the detection that the video connection is not to be continued occurring after a video connection had already been established between the online meeting and the participant computing system.

19. The method in accordance with claim 18, the detection that the video connection is not to be continued occurring in response to monitoring video quality presented over the video connection.

20. A computing system comprising:
one or more processors; and
one or more computer-readable media having thereon computer-executable instructions that are structured such that, when executed by the one or more processors, cause the computing system to perform a method for failing over an online meeting to a non-video connection with the online meeting, the method comprising:
detecting that a video connection to a meeting service is not to be made or continued between an online meeting that is hosted by an online meeting computing system and a participant computing system that interfaces with a participant in the online meeting, wherein if the detection is a detection that a video connection is not to be made, the detection that a video connection is not to be made occurring in response to attempting to join the participant into the online meeting and there being a difficulty with joining the participant using the video connection, wherein if the detection is a detection that a video connection is not to be continued, the detection that the video connection is not to be continued occurs after a video connection had already been established between the online meeting and the participant computing system and occurring in response to monitoring video quality presented over the video connection; and
in responding to the detection, providing a non-video connection between the participant computing system and an online meeting, the non-video connection allowing still image sequences and audio, but not video, to be delivered to the participant computing system for rendering to the participant.
